(19) United States
(12) Patent Application Publication
(10) Pub. No.: US 2005/0006285 A1
(43) Pub. Date: Jan. 13, 2005

(54) Sheet discriminator, sheet discriminating method and sheet discriminating threshold value deciding method

(75) Inventors: Tetsuo Watanabe, Tokyo (JP); Yukio Asari, Kanagawa-ken (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/868,978

(22) Filed: Jun. 17, 2004

(30) Foreign Application Priority Data
Jul. 10, 2003 (JP) 2003-195188
Nov. 25, 2003 (JP) 2003-394585

(51) Int. Cl. G03G 15/00

(52) U.S. Cl. 209/534

(57) ABSTRACT

A sheet discriminator includes a pair of conveyor belts arranged with a specified space between them in parallel with the conveying direction in the direction orthogonal to the sheet conveying direction and put over pulleys to curve so as to hold and convey a sheet along the conveying path; a pair of reference rollers arranged between a pair of conveyor belts with a specified space in the direction orthogonal to the sheet conveying direction to hold a sheet being conveyed, and a pair of thrusting rollers arranged in contact with a pair of reference roller with the conveying path between them and thrust a sheet against the reference rollers. Further, a sheet discriminator includes a sensor roller provided between a pair of reference rollers projecting from the sheet conveying surface and moving in the direction orthogonal to the sheet conveying surface when a sheet is held and conveyed by a pair of conveyor belts, and a position sensor to detect the moving position of the sensor roller or the sheet surface position when a sheet passes the sensor roller.

### CROSS-REFERENCE TO RELATED APPLICATION

This application is based upon and claims the benefit of priority from the prior Japanese Application No. 2003-195188, filed on Jul. 10, 2003 and Japanese Application No. 2003-394585, filed on Nov. 25, 2003; the entire contents of which are incorporated herein by reference.

### BACKGROUND OF THE INVENTION

1. Field of the Invention

This invention relates to a sheet discriminator, a sheet discriminating threshold value deciding method and a sheet discriminating method that are applicable to, for example, a cash processor.

2. Description of the Related Art

A cash arranger is composed of a receiver, a discriminator, a reject stacker, a stacker, a switch-back unit, a front/back reversing unit, a banding unit, a cutting unit, a conveying path connecting respective units, and a gate to sort sheets to respective units.

Banknotes (hereinafter, called as paper sheets) set in a take-in unit are separated to each sheet and taken in, conveyed to a discriminator and destinations (a reject stacker, a stacker, a banding portion, a cutting portion) and conveying routes (whether the front/back or top/bottom should be reversed by passing through a switch-back portion, a front/back reversing portion) are determined. After this decision, a sheet is conveyed to respective units through the conveying path and a gate and processed as necessary.

In a discriminator of this cash arranger, after kinds of banknotes are determined, true or false, good or stained state are discriminated by optically detecting dual conveying of two sheets in the overlapped state, stained sheets having a hole, dirty sheets by doodling on the surfaces.

However, the optical detection only is not sufficient to determine a sheet for the good or stained state and such physical values expressing the state of a sheet presented by degree of fatigue, stiffness of a sheet, degree of wrinkles cannot be detected fully and a technology is needed to discriminate the right or wrong of a sheet from mechanical physical values.

As a method to discriminate the good or stained state of a sheet from mechanical physical values, there is a method to detect stiffness of banknotes (rigidity) by detecting a reaction force retained by banknotes as disclosed in International Published Patent Application No. WO99/50797.

However, as a sheet was so far conveyed to a sensor roller by holding it with conveying roller pairs, a sheet would be conveyed while bumping rollers (a driving roller, pinch rollers) projecting to the conveying surface and especially when a sheet is conveyed at a high speed, the conveying speed was decelerated or the jamming was caused in some cases.

Further, an reaction force of a sheet is detected so far based on a strain when a sheet is passing through a sensor roller and its deflection is discriminated on the basis of the strain when a sheet does not pass through the sensor roller using a strain gage; however, the calibration of a sensor was necessary for fluctuation of sensitivity between sheet discriminators.

### SUMMARY OF THE INVENTION

This invention is made based on the above-mentioned circumstances and it is an object to provide a sheet discriminator that enables the stabilized and high-speed conveying of a sheet.

Another object of this invention is to provide a sheet discriminating method requiring no calibration of a sensor for variation of sensitivity of a sensor between sheet discriminators, and further to provide a sheet discriminating threshold value deciding method capable of discriminating the right/wrong of a sheet at the sensitivity close to the human hand touch feeling.

According to the embodiments of this invention, there is provided a sheet discriminator comprising: a pair of conveyor belts provided in parallel with the conveying direction with a specified space in the direction orthogonal to the conveying direction of sheets and put over pulleys to curve so as to hold and convey sheets along the conveying path; a pair of reference rollers provided between the conveyor belt pairs with a specified space in the direction orthogonal to the conveying direction of the sheets; a pair of thrusting rollers provided in contact with the conveyor belt pairs to thrust the sheets against the reference rollers; a sensor roller provided between the reference roller pairs projecting from the sheet conveying surface, and moves in the direction orthogonal to the sheet conveying surface when the sheets that are held and conveyed by passed; and a position sensor to detect the moving position of the sensor roller or to detect the surface position of the sheets when the sheets pass the sensor roller.

Further, according to the embodiments of this invention, there is provided a sheet discriminating method using a position sensor that contacts sheets conveyed by a conveying unit to detect the moving position of a sensor roller moving in the direction orthogonal to a conveying surface of the sheet or a surface position of the sheet comprising: collecting digital data group digitized to minute unit time from a single sheet based on a voltage value as an output result from the position sensor; obtaining a relative differential degree of stiffness by obtaining a frequency distribution of position data as index expressing stiffness of the sheet from the collected digital data group and calculating a peak value or an average value in the frequency distribution; and discriminating good or stained state of the sheets based on the comparison of the relative differential degree of stiffness with a pre-stored threshold value.

Further, according to the embodiments of this invention, there is provided a sheet discriminating threshold value deciding method of a sheet discriminator using a position sensor that contacts sheets conveyed by a conveying unit to detect a moving position of the sensor roller moving in the direction orthogonal to a conveying surface of the sheets or a surface position of the sheets comprising: collecting digital data group digitized to minute unit time from a single sheet based on a voltage value as a output result from the position sensor for a first reference sheet and a second reference sheet conveyed by the conveying unit; obtaining frequency distributions of position data as indexes expressing stiffness of the first and the second reference sheets from the collected digital data group and obtaining a relative differential degree of stiffness by calculating a peak or an average value in the frequency distribution; mapping relative differential degrees of stiffness of the first and second reference sheets, respectively; estimating a standard for zero stiffness of sheets from the positions of the first and the second reference sheets on the map; setting plural threshold values by dividing the map into plural stages based on the standard; and selecting one threshold value out of the plural threshold values.

### BRIEF DESCRIPTION OF THE DRAWINGS

FIG. 1 is a block diagram showing a cash arranger that is one embodiment of this invention;

FIG. 2 is a schematic diagram showing the construction from a take-out portion to a discriminator of the cash arranger shown in FIG. 1;

FIG. 3 shows a first embodiment of a paper quality sensor in one embodiment of this invention, FIG. 3A is a side view and FIG. 3B is a front view and FIG. 3C is a schematic diagram showing an irruptive angle of a paper sheet into a sensor roller;

FIG. 4 is a side view showing a second embodiment of the paper quality sensor;

FIG. 5 is a third embodiment of the paper quality sensor, FIG. 5A is a side view, FIG. 5B is a front view, and FIG. 5C is a schematic diagram showing an irruptive angle of a sheet into the sensor roller;

FIG. 6 is a fourth embodiment of the paper quality sensor, FIG. 6A is a side view and FIG. 6B is a schematic diagram, showing an irruptive angle of a sheet into the sensor roller;

FIG. 7 shows a fifth embodiment of the paper quality sensor,

FIG. 7A is a side view and FIG. 7B is a schematic diagram showing an irruptive angle of a sheet into the sensor roller;

FIG. 8 is a graph showing an output example of a position sensor;

FIG. 9 shows the state of the sensor roller that is not in contact with a sheet, FIG. 9A is a side view showing a first embodiment and

FIG. 9B is a side view showing a second embodiment;

FIG. 10 is a graph showing the output (position data) of a digital data group collected by the paper quality sensor;

FIG. 11 is a graph showing a two-dimensional mapping of index representing the state of a sheet;

FIG. 12 is a graph showing a first embodiment of a right/wrong discriminating standard for the two-dimensional mapping;

FIG. 13 is a graph showing a second embodiment of the right/wrong discriminating standard for the two-dimensional mapping;

FIG. 14 is a graph showing the results of discrimination of a sheet for right/wrong;

FIG. 15 is a graph showing the relationship of the two-dimensional mapping with the sensory evaluation result;

FIG. 16 shows the sensor outputs, FIG. 16A is a side view showing a V-shape bent sheet, FIG. 16B is a graph showing an amplitude of detected output of the V-shape bent sheet, and FIG. 16C is a graph showing its average value;

FIG. 17 shows the sensor output to a sheet, FIG. 17A is a side view showing a multiple V-shape bent sheet, FIG. 17B is a graph showing amplitude of detected output of multiple V-shape bent sheet, and FIG. 17C is a graph showing its average value;

FIG. 18 shows an advance work to decide a paper quality discriminating standard, FIG. 18A is a graph showing a two-dimensional map of stiffness relative difference and wrinkle relative difference, and FIG. 18B is a graph showing the state with an absolute standard provided on two-dimensional map;

FIG. 19 shows a two-dimensional map, FIG. 19A is a graph showing the state of a two-dimensional map divided into several stage based on reference ranges and FIG. 19B is a graph showing the distribution state of sheets discriminated for the right/wrong;

FIG. 20 is a flowchart showing the flow of a cash processing operation;

FIG. 21 shows a sixth embodiment of a paper quality sensor,

FIG. 21A is a side view, FIG. 21B is a front view and FIG. 21C is a schematic diagram showing a paper sheet irruptive angle to a sensor roller; and

FIG. 22 shows a seventh embodiment of a paper quality sensor,

FIG. 22A is a side view and FIG. 22B is a schematic diagram showing a sheet irruptive angle to a sensor roller.

### DETAILED DESCRIPTION OF THE INVENTION

This invention will be explained below in detail referring to preferred embodiments shown in the attached drawings.

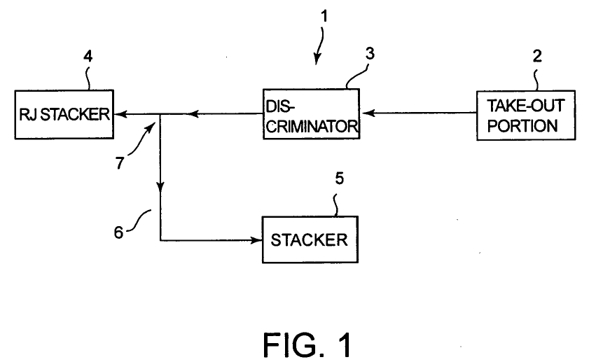

FIG. 1 is a schematic diagram showing a cash arranger that is an embodiment of this invention.

A cash arranger 1 is composed of a take-out portion 2, a discriminator (a discriminating means) 3, a reject stacker 4 and a stacker 5, a conveying path 6 for connecting these units, and a gate 7 to sort paper sheets by a conveying course.

Take-out portion 2 separates and taken out sheet papers and sends to discriminator 3 (a discriminating unit).

Upon determining type of a paper sheet, discriminator 3 discriminates the paper sheet for good or stained state and detects dual conveying of more than two sheets in the overlapped state. Further, discriminator 3 discriminates paper sheets for the good/stained from mechanical material values by optically detecting presence of holes/damages of paper sheets, dirty surfaces, etc.

Gate 7 sorts paper sheets according to the result of discrimination by discriminator 3. When a paper sheet is a false sheet, sends it to reject stacker 4. Good and stained sheets of true sheets are sent to stacker 5 and stacked by good and stained sheets and further, good sheets are separated and stacked by values.

Take-out portion 2 separates and takes out paper sheets and sends to discriminator (a discriminating unit) 3.

Discriminator 3 determines the paper sheet for true or false and detects dual conveying of more than two paper sheets in the overlapped state. Further, discriminator 3 optically detects paper sheets for presence of holes, dirty surface and discriminates the good or stained state from mechanical material values.

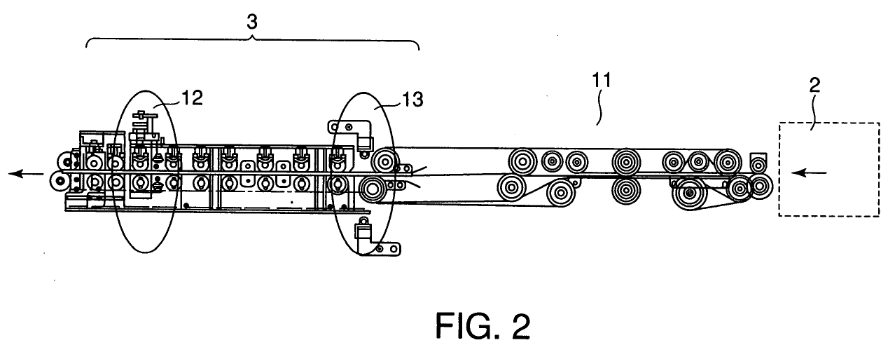

FIG. 2 is a schematic diagram showing the structure from take-out portion 2 to discriminator 3.

The paper sheets separated and sent by take-out portion 2 pass through a conveying unit 11 provided in front of the discriminator as a part of conveying path 6 and are conveyed to discriminator 3.

In discriminator 3, paper quality sensor (a calculating unit) 12 is provided as a detector jointly with various sensors and the paper sheets passing various sensors are conveyed to a latter step by conveying path 6. To detect paper sheets arrived at various sensors including paper quality sensor 12 in discriminator 3, a trigger (an optical sensor) 13 is provided in conveying unit 11 and a signal showing the passing of paper sheets through the various sensors is sent to discriminator 3.

In this embodiment, conveying unit 11 is a belt holding conveying path, discriminator 3 is a roller holding conveying path, and a unit after discriminator 3 is a belt holding conveying path.

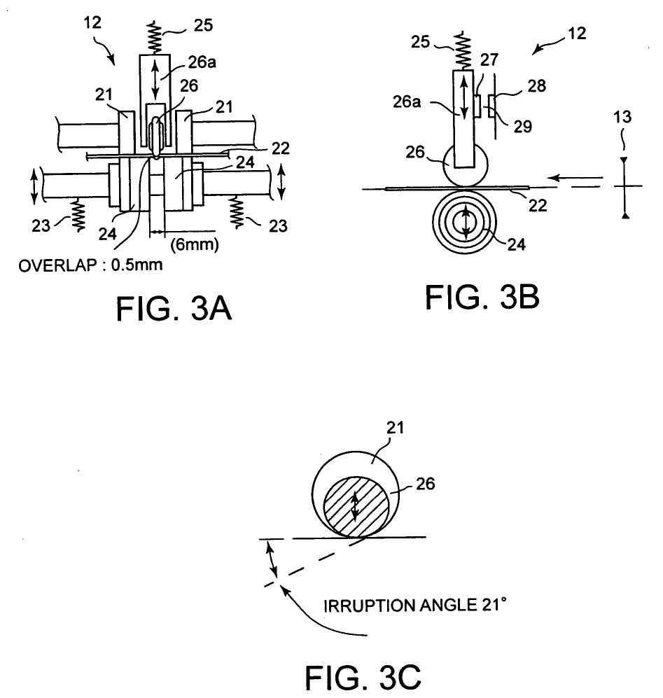

FIG. 3A to FIG. 3C show a first embodiment of paper quality sensor 12.

More than one unit of paper quality sensor 12 are provided with a specific space in the direction orthogonal to the conveying direction of paper sheet 22 and reference roller pairs 21 which are driven as driving rollers are provided. Pinch rollers 24 and 24 are contacted to the lower sides of reference rollers 21 and 21. Pinch rollers 24 and 24 are pressed toward reference rollers 21 and 21 by springs 23 and 23.

Between reference rollers 21 and 21, a sensor roller 26 is provided. This sensor roller is held by a holder 26a. Holder 26a is pressed downward by a spring 25 and sensor roller 26 is overlapped on the sheet conveying surface.

At the side of holder 26a, a magnet 27 is provided. Near magnet 27, a magneto-resistive element 28 is provided. A position sensor 29 to detect the position data when sensor roller is moved is composed of magnet 27 and magneto-resistive element 28.

When a conveyed paper sheet 22 is introduced between reference rollers 21 and 21 and pinch rollers 24 and 24, sensor roller 26 projecting on the paper sheet conveying surface is moved in the direction orthogonal to paper sheet conveying surface and the position of sensor roller 26 is detected by position sensor 29 that is a position detecting means.

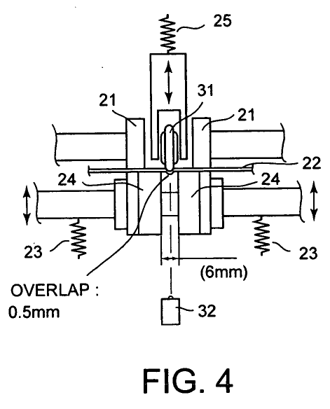

FIG. 4 shows a second embodiment of paper quality sensor 12.

The same elements shown in the first embodiment will be assigned to the same elements and their explanations will be omitted.

In the second embodiment, an overlap roller 31 is provided between reference rollers 21 and 21 but a position sensor to detect the position of overlap roller is not provided. Instead, a laser displacement meter 32 is provided at the opposite face side of the conveying surface as a position sensor to detect the position data of the surface of paper sheet 22.

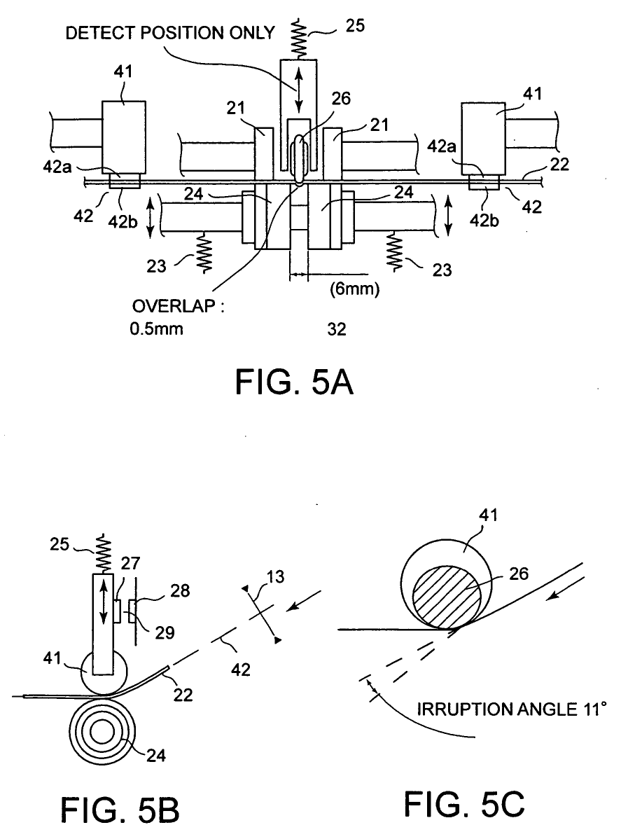

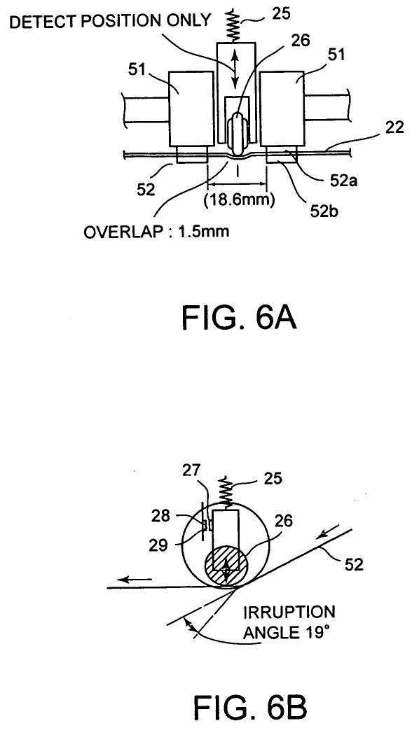

FIG. 6A to FIG. 5C show a third embodiment of paper quality sensor 12.

In this third embodiment, there are conveyor belt pairs 42 provided parallel to each other with a specific space in the direction orthogonal to the conveying direction of paper sheet 22. Conveyor belt pairs 42 have upper and lower conveyor belts 42a and 42b and paper sheet 22 is conveyed by holding with these upper and lower conveyor belts 42a and 42b.

A pair of conveyor belts 42 and 42 are put over pulleys 41 and 41, respectively and curved. Between these curved portions, reference roller pairs 21 and 21, pinch roller pairs 24 and 24 and further, sensor roller 26 are provided.

In the third embodiment, a paper sheet 22 is held and conveyed between reference roller pairs 21 and 21 and pinch roller pairs 24 and 24 by conveyor belt pairs 42 and 42. Therefore, the possibility for paper sheets conveyed while striking the driving rollers and pinch rollers which are projecting to the conveying surface as in a case of conveying between rollers on the roller holding conveying path will decrease and it becomes possible to stably detect paper quality even when the conveying velocity of a paper sheet 22 is accelerated to a high speed.

Further, a pair of reference rollers 21 and 21 and pinch rollers 24 and 24 and further, a sensor roller 26 are provided near the curved portion of conveyor belt pairs 42 and 42. Therefore, a paper sheet 22 is irrupted into the overlapped portion (the projecting portion) of sensor roller 26 in the state along the curved portion of conveyor belt pairs 42 and 42, its irruptive angle (for example 11°) can be made small. Accordingly, it becomes possible to suppress the vibration of sensor roller 26 by the irruptive shock of a paper sheet.

FIG. 6A and FIG. 6B show a fourth embodiment of paper quality sensor 12.

Further, the same component elements as those shown in the first embodiment will be assigned with the same reference numerals and their explanations will be omitted.

In the fourth embodiment, conveyor pulley pairs 51 and 51 are provided as a pair of reference rollers with a specific space between them in the direction orthogonal to the conveying direction of a paper sheet 22 and conveyor belt pairs 52 and 52 are put over conveyor pulleys 51 and 51 and curved. Pair of conveyor belts 52 and 52 have upper and lower conveyor belts 52a and 52b which are overlapped and arranged in parallel to each other along the conveying direction of a paper sheet 22.

Sensor roller 26 is provided between conveyor pulley pairs 51 and 52 and located near the curved portions of a pair of conveyor belts 52 and 52.

Paper sheet 22 conveyed into sensor roller 26 portion while held by a pair of conveyor belts 52 and 52. At this time, conveyor belts 52b and 52b below a pair of conveyor belts 52 and 52 escape downward by a thickness of a paper sheet 22.

The overlap amount of sensor roller 26 (a projecting amount from the conveying surface of a paper sheet) (1.5 mm) is larger than that in the first embodiment (0.5 mm). However, because sensor roller 26 is provided near the curved portion of conveyor belt pairs, a paper sheet 22 irrupts into the overlapped portion of sensor roller 26 in the state along the curved portion. Thus, the irruptive angle (19°) of paper sheet 22 to sensor roller 26 can be made to the same level in the first embodiment (21°) and it becomes possible to increase the overlap amount of sensor roller 26 without increasing the vibration of sensor roller 26 by the irruptive shock.

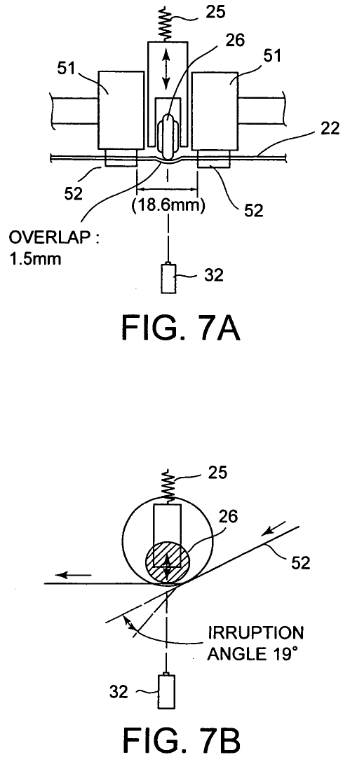

FIG. 7A and FIG. 7B show a fifth embodiment of paper quality sensor 12.

Further, the same component elements as those shown in the fourth embodiment will be assigned with the same reference numerals and explanations thereof will be omitted.

In the fifth embodiment, a position sensor for detecting a position of sensor roller 26 is not provided. Instead, laser displacement meter 32 is provided for detecting a surface position data of a paper sheet 22 at the opposite face side of the conveying surface.

That is, the fifth embodiment is in such a structure that laser displacement meter 32 is provided for position sensor 29 as in the second embodiment.

According to the fifth embodiment, it is possible to increase the overlap amount of sensor roller 28 without increasing the vibration of sensor roller 26 by the irruptive shock of a paper sheet 22 likewise the fourth embodiment.

In the above-mentioned first to fifth embodiments, position sensor 28 is in the same structure as described in Japanese Published Unexamined Patent Application No. 2002-90103 “Sheets Thickness Detector”. However, in this embodiment, a displacement is not detected but only a position data of sensor roller 27 when a paper sheet 22 is passing paper quality sensor 12 is detected. That is, a sensor described in Japanese Published Unexamined Patent Application No. 2002-90103 has a magnet for detecting displacement fixed at almost the center of the vertical wall portion of a holder connected to a plate spring of a vertical plate spring portion. This magnet has a displacement sensor applied with a magneto-resistive element provided with a space as a sensor opposing to the magnet. Further, the displacement sensor applied with a magneto-resistive element is mounted on one side of the circuit board for displacement output signal amplification. This circuit board is attached to the inner surface of a sensor case. On the other side of the circuit board, a magnet for biasing is attached.

Further, position sensor 29 may be of non-contact type using a magneto-resistive element but the position data of sensor roller 26 may be detected by measuring a strain amount of a cantilever with a strain gage as disclosed in Japanese Published Unexamined Patent Application No. 2000-357254 “Sheets Thickness Sensor”. That is, the sheets thickness detector disclosed in Japanese Published Unexamined Patent Application No. 2000-357254 is provided with a stationary roller fixed to a shaft and a movable roller in the vertically movable holding structure mutually opposite to a sheets conveying path and detects a displacement amount of the movable roller when sheets pass between both rollers as a thickness of sheets. In other words, the displacement of the movable roller produced corresponding to a thickness of sheets is transmitted to a cantilever and a thickness of sheets is detected by detecting an amount of strain produced on this cantilever by a strain gage fixed to the cantilever.

Further, sensor roller 26 and overlap roller 31 in the embodiments 1 to 5 can be general ball bearings or structures having the contact surface in the shape not impeding the conveying of a paper sheet 22.

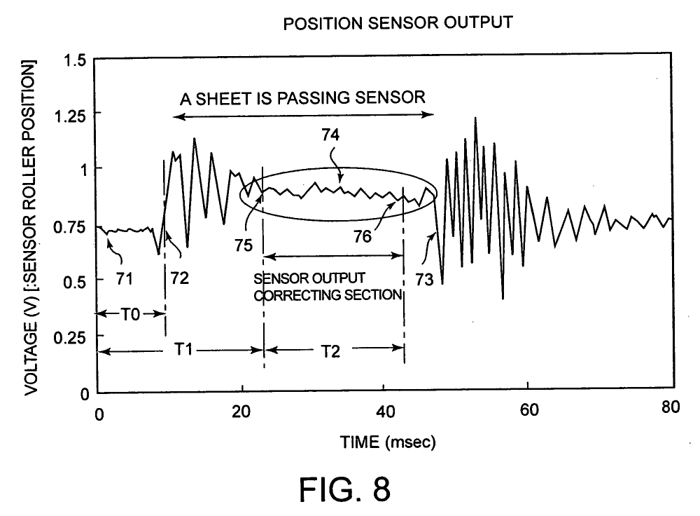

Next, the functions and algorithm of paper quality sensor 12 will be explained referring to FIG. 8 to FIG. 10.

FIG. 8 shows an output example of the position sensor.

However, in this embodiment, outputs of all wave shape sections are collected but outputs of only limited sections are collected. Output examples in the shape similar to this are observed by position sensor 29 or laser displacement meter 32 in the above-mentioned embodiments 1 to 5.

The output example shown in FIG. 8 is measured by position sensor 29 and an electric signal (voltage) of the magneto-resistive element detected corresponding to the moved position of magnet 27 is given as an output for a position data.

Here, the relationship between the actual movement of a paper sheet and the output shown in FIG. 8 will be explained.

Paper sheet 22 passed through trigger sensor 13 irrupts into sensor roller 26 that is overlapped on the conveying surface of paper quality sensor 12 after a given amount of time and advances while lifting up sensor roller 26 and goes out of paper quality sensor 12.

In FIG. 8, a time when paper sheet 22 passes trigger sensor 13 is a trigger timing 71, a time when paper sheet 22 irrupts into sensor roller 26 after a given amount of time is a paper sheet irruptive time 72, and a time when paper sheet 22 goes out of sensor roller 26 is a paper sheet unthread time 73. The output of position sensor 29 oscillates largely as shocked largely at the paper sheet irruptive time 72 when the paper sheet irrupts and when the oscillation is gradually stabled and a stable area is obtained.

Therefore, output data of position sensor 29 is collected only for output from a sensor output collection start time 75 to a sensor output collection completion time 76, and outputs of trigger timing 71, paper sheet irruptive time 72, paper sheet unthread time are not collected. That is, output is not collected for a time from trigger timing 71 to sensor output collection start time 75 and output after sensor output collection completion time 76 is not collected.

In the subsequent processes to the paper quality discrimination, the detection result (a voltage value) of outputs collected from sensor output collection start time 75 to sensor output collection completion time 76 are used directly as an as-is numerical value (a voltage value) without taking any other actions, for example, to convert into a displacement amount by reducing a difference from the reference output. (Because no standard output is detected from the above, a difference also cannot be reduced.)

Next, the relationship of the movement of paper sheet 22 with the movement and function of paper quality sensor 12 will be explained.

In the process of conveying paper sheet 22, with trigger timing 71 when the leading edge of a paper sheet 22 passes trigger sensor 13 as a standard, a time after a given amount of time (T1) is assumed as sensor output collection start time 75. After a given amount of time from passing trigger sensor 13 (TO: determined by the position of the trigger), paper sheet 22 irrupts into sensor roller 26 or overlap roller 31. Then, at sensor output collection start time 75, the position data of sensor roller 26 or the position data of the surface of paper sheet pressed by overlap roller 31 is detected as a voltage value by position sensor 29 or laser displacement meter 32 and the output is collected.

Thereafter, a time after a given amount of time (T2) from sensor output collection start time 75 is assumed as sensor output collection completion time 76 and the collection of output is completed at sensor output collection completion time 76.

The above-mentioned sensor output collection process is to collect sensor output for the period of T2 on the basis of trigger timing 71 disregarding whether paper sheet 22 contacts sensor roller 26 or overlap roller 31 when passing paper quality sensor 12. As an example, in 20 ms of period T2, the sensor output is sampled for every 1 ms and 20 output data are collected. Further, the period of collection, every time of collection and number of output data may be not limited the above.

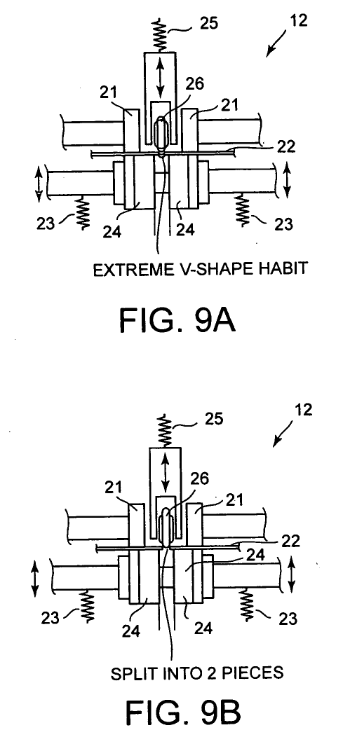

Here, paper sheet 22 does not contact sensor roller 26 or overlap roller 31 when, for example, paper sheet 22 in the extremely V-shape habit is taken into paper quality sensor 12 as shown in FIG. 9A or when paper sheet 22 split into two pieces was taken in paper quality sensor 12 as shown in FIG. 9B.

In this case, the state of “extremely in the V-shaped habit” or “split in two pieces” cannot be sensed exactly only by paper quality sensor 12 and another sensing means is needed to exactly detect such a state. However, a voltage value of the output result in paper quality sensor 12 becomes extremely lower than other paper sheets and therefore, stiffness of that paper sheet is regarded extremely weak and judged as an object for rejection at a very high probability.

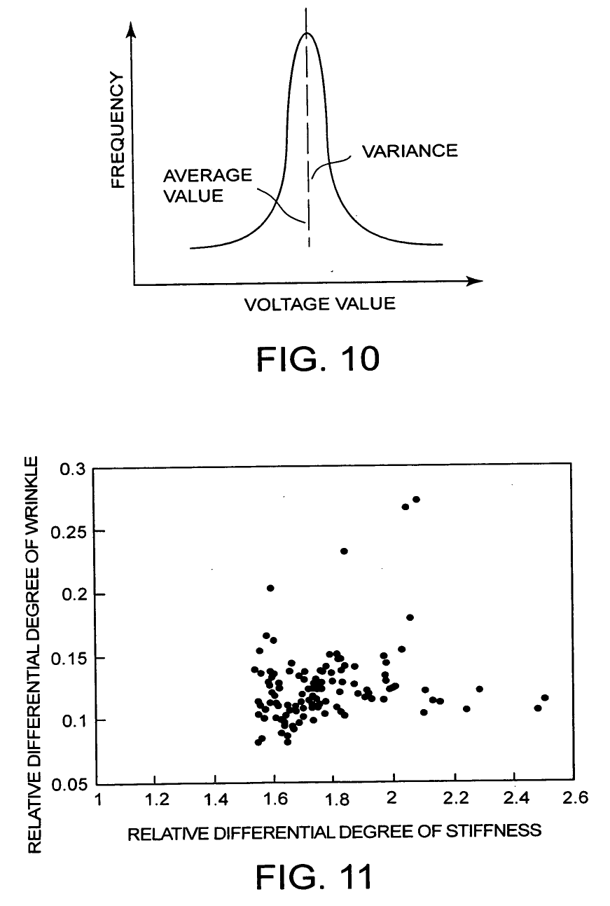

Paper quality sensor 12 takes out voltage values as sampling digital data, for example, per 1 ms and collects 20 digital data groups in the period from sensor output collection start time 75 to sensor output collection completion time 76 in this voltage value output collection process. These 20 digital data groups are distributed when the voltage value output frequencies are shown in a graph as shown in an output (position data) distribution diagram in FIG. 10.

The thus collected digital data groups are distributed as shown in FIG. 10. This distribution has different fluctuations according to the state of paper sheet 22 centering on average values differing by the state of paper sheet 22. A peak value or an average value (a voltage value of peak portions) is strongly related to a degree of stiffness of paper sheet 22 and the fluctuation is strongly related to a degree of wrinkles of paper sheet 22.

Therefore, a peak or an average value is calculated from obtained digital data groups as an index showing a degree of stiffness of paper sheet 22 and a standard deviation as an index showing a degree of wrinkles of paper sheet 22.

However, as the collected digital data groups do not contain reference output, an absolute standard (an original point) and an absolute range cannot be given to a difference of the output results between paper sheets 22 and the relative state ranking only can be made.

So, the peak value or the average value calculated in the above is called as a relative differential degree of stiffness and a standard deviation is called as a relative differential degree of wrinkle.

Thus, paper quality sensor 12 collects position data of sensor roller 26 or surface of paper sheets when paper sheets 22 are passing sensors as digital data groups and by obtaining a peak or an average value or standard deviation, calculates a relative differential degree of stiffness and a relative differential degree of wrinkle of the state of paper sheets.

Next, the algorithm of discrimination of good/stained state of paper sheet 22 will be explained referring to FIG. 11 to FIG. 16.

FIG. 11 shows a two-dimensional mapping of indexes showing the state of paper sheets 22.

That is, sensor outputs during the sensor output collection period are sampled for every 1 ms as described above and by making the A/D conversion, 20 digital data are obtained. From 20 digital data (X1, X2, X3 . . . , Xn) (n=20) thus obtained, an average value is obtained according to the following calculating formula:

$$\overline{x} = \frac{1}{n} {\sum }_{i = 1}^{n} {x}_{i}$$

This average value x is a relative differential degree of stiffness showing the stiffness of paper sheet.

Further, according to the following calculating formula, a variation of value (standard deviation) is obtained from 20 digital data:

$${σ}^{2} = \frac{1}{n} {\sum }_{i = 1}^{n} {( {x}_{i} - \overline{x} )}^{2}$$

This variation becomes a relative differential degree of wrinkle expressing a degree of wrinkle.

For example, a chart plotted based on a relative differential degree of stiffness and that of relative difference of wrinkle obtained for 120 paper sheets is a graph of relative differential degree of stiffness/relative differential degree of wrinkle.

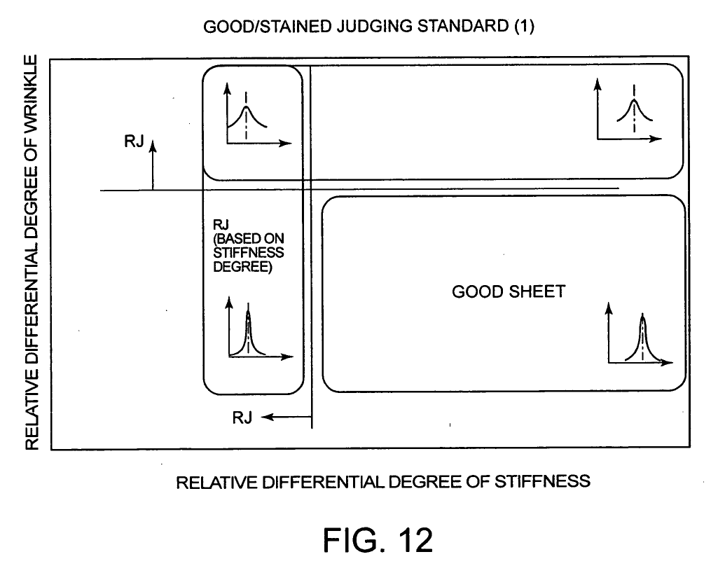

Further, shown in FIG. 12 is one example showing the standard for discriminating good/damage state of paper sheet in such the graph of a relative differential degree of stiffness/wrinkle. In FIG. 12, the more stiffness becomes weak in the left side (a relative differential degree of stiffness becomes small) and the more becomes stronger in the right side (a relative differential degree of stiffness is large). Further, the more wrinkle becomes much in the above (a relative differential degree of wrinkle becomes less) and the less wrinkle becomes (a relative differential degree is small). Accordingly, with threshold values are pre-set for relative differential degrees of stiffness and wrinkle, paper sheets with weak stiffness and much wrinkles are discriminated for good or damage.

Threshold values for relative differential degrees of stiffness and wrinkle can be changed every time according to conditions depending upon what state of paper sheets should be determined good or stained.

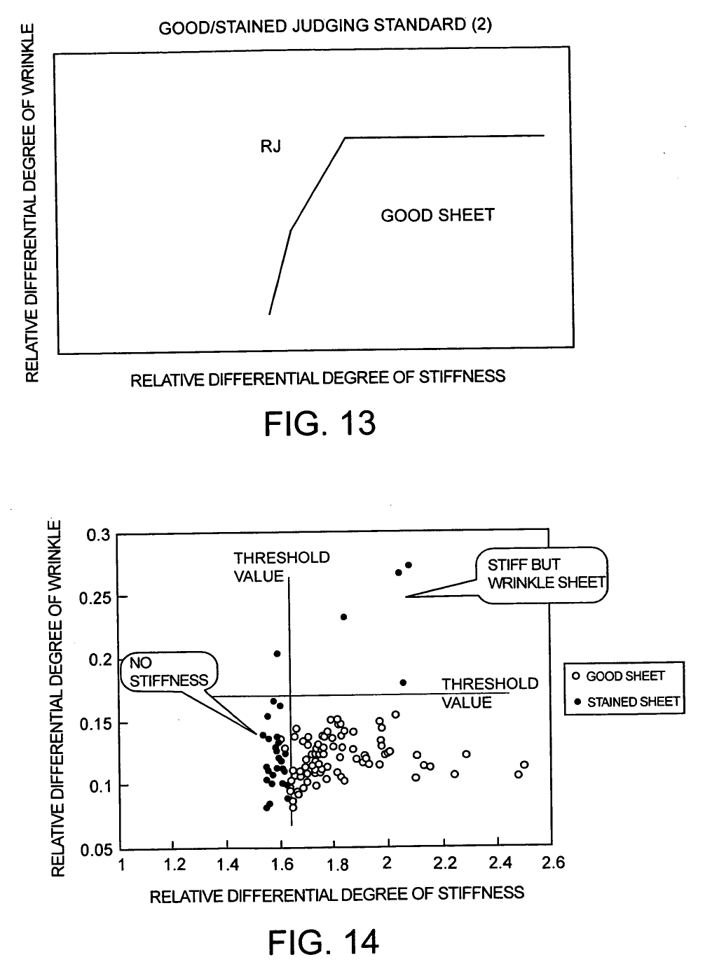

Further, FIG. 13 is a second example showing the standard for discriminating the good or stained state of paper sheets.

In FIG. 13, a standard for discriminating may be given from the mutual relationship between relative differential degrees of stiffness and wrinkle instead of giving independent threshold values for relative differential degrees of stiffness and wrinkle.

FIG. 14 shows the results of discrimination of paper sheets for good or stained state.

Certain threshold values for relative differential degrees of stiffness and wrinkle are given in advance to the two-dimensional mapping in FIG. 11 as shown in FIG. 12. Then, relative differential degrees for stiffness and wrinkle are obtained from actual paper sheets and paper sheets are discriminated for good or stained state by comparing with the threshold values. Paper sheets are thus classified as good or to be rejected.

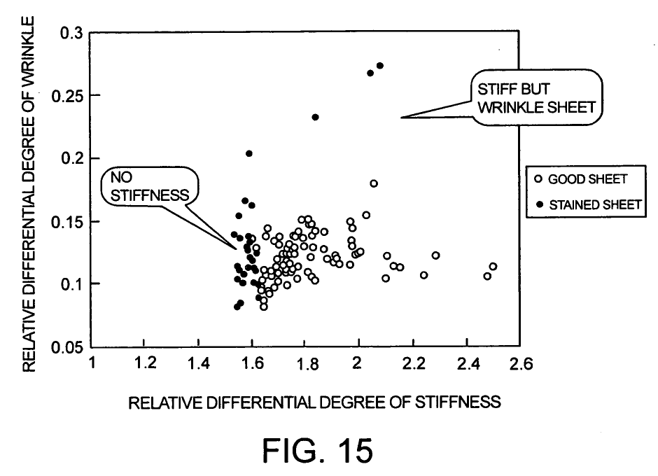

FIG. 15 shows the relation of the two-dimensional mapping with the result of sensual evaluation.

Here, 120 sheets of paper (as evaluation media) were prepared, processed by a paper quality discriminator and two-dimensionally mapped. On the other hand, 30 sheets were intuitively extracted one by one for the sensual evaluation from those sheets applicable to stained sheets out of 120 sheets of paper by 10 evaluators. The relation of the two-dimensional mapping and the sensual evaluation is shown here.

In FIG. 15, from paper sheets that were judged as stained sheets by many evaluators out of 120 sheets are discriminated as stained sheets (black circles) and other sheets are judged as good sheets (white circles). By comparing this result with FIG. 14, it is seen that it is possible to determine paper sheets for good or stained state at the feeling more close to the human hand feeling.

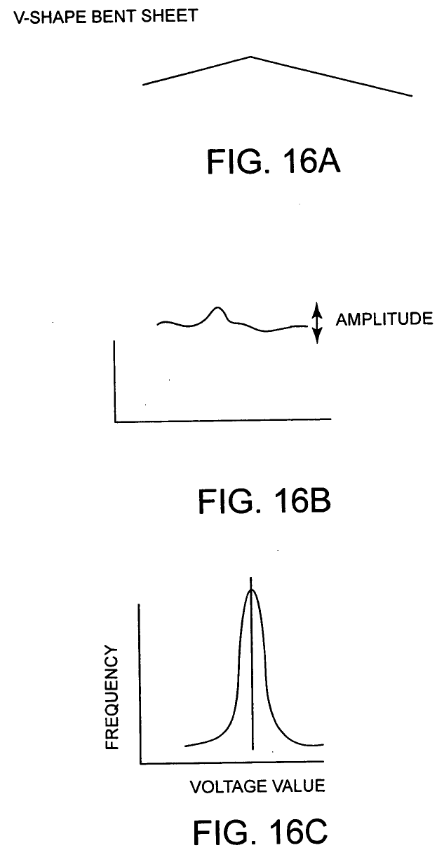

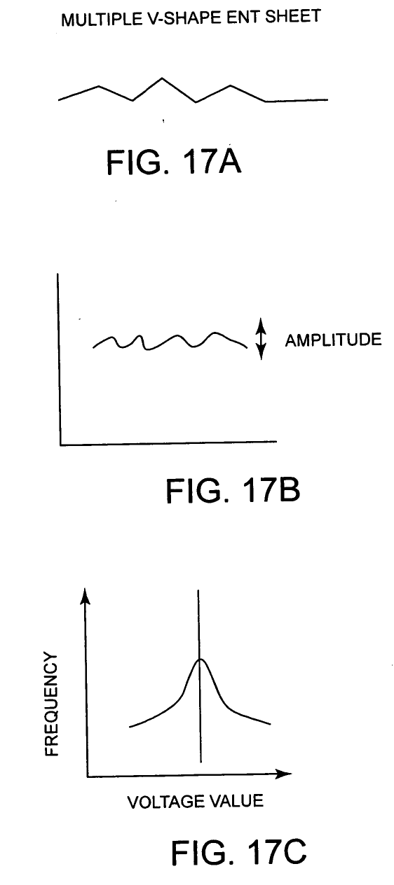

In the calculating method of amount expressing the state of wrinkle, a calculating method to see amplitude of collected data is also considered. However, the effect of a calculation method using variation of collected data (standard deviation) in this embodiment will be explained referring to FIG. 16 and FIG. 17.

FIG. 16 is a diagram showing a V-shape bent paper sheet and

FIG. 17 is a diagram showing the sensor output to multiple bent paper and the distribution of number of samplings.

In FIG. 16 and FIG. 17, a multiple V-shape bent paper sheet is generally considered more close to a stained sheet than a V-shape bent sheet. Here, when paying attention to amplitude, it is difficult to differentiate a V-shape bent sheet and a multiple V-shape bent sheet but when checking variation, it is possible to judge that a multiple V-shape bent sheet is close to a stained sheet at a higher probability. As a result, “a stiff but wrinkled sheet” shown in FIG. 15 can be discriminated for good or stained state at a feeling more close to a human hand feeling.

The good or stained state of paper sheets can be judged by the above-mentioned means. However, pertinent values are given to threshold values for relative differential degrees of stiffness and wrinkles so that desired results are obtained in the above good or stained state discrimination. Therefore, there is no measure for what threshold values should be given to get desired a good/stained state discrimination result and therefore, it is considered necessary to do over the process until proper threshold values are given. For example, it is insufficient to apply the above-mentioned good/stained state discrimination means to the paper quality discriminator that is used in a cash arranger.

This is because an absolute standard (the point of origin) and an absolute range cannot be set for amounts expressing stiffness and wrinkles as outputs that become standards are not detected in the paper quality sensor.

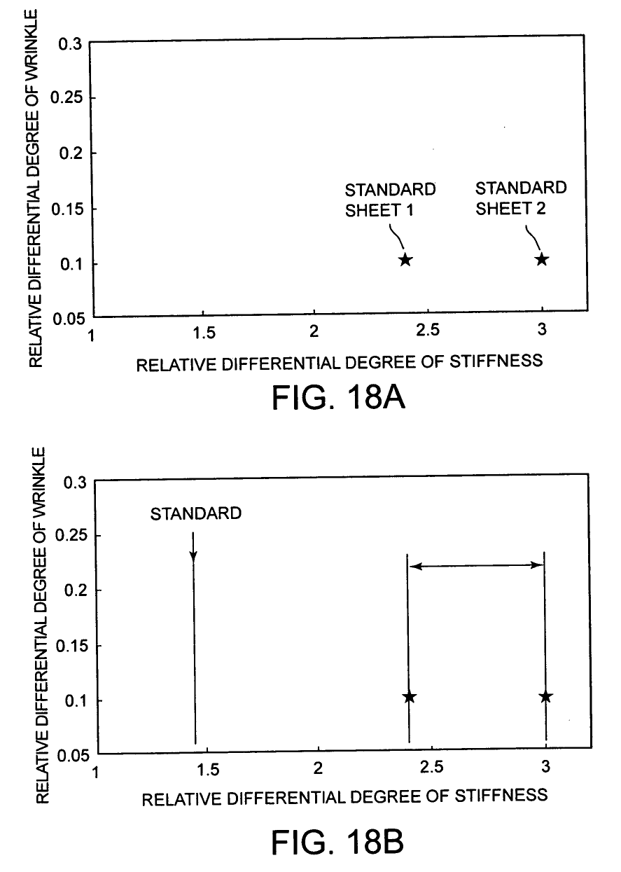

A means to solve this problem will be explained below referring to an example of a good/stained sheet discrimination standard deciding means using two reference paper sheets as shown in FIG. 18.

In order to solve the above-mentioned problem, an advance work to determine a paper quality determining standard explained below is performed before actually using a cash arranger including a paper quality discriminator.

However, regarding wrinkles, standard variations of collected data are observed and it is considered that not much difference for variance of standard is observed. Therefore, it is considered that the advance work to determine the paper quality discrimination standard is not needed for wrinkles and an advance work to determine the paper quality standard for only stiffness is performed.

First, prepare two reference paper sheets (2 kinds in different stiffness) in advance. Here, an absolute value of amount expressing the state of stiffness of reference paper sheets must be already known. In other words, it must be already known where stiffness of reference paper sheets is ranked in an absolute range against general circulated paper sheets.

As the advance work, these two reference sheets are put into a cash arranger that includes a paper quality sensor and a relative differential degree of stiffness obtained by a method described above and two-dimensionally mapped as shown in FIG. 18A.

Values of absolute differential degrees of stiffness and wrinkles of these two reference sheets are already known and therefore, standards can be estimated as shown in FIG. 18B from the positional relation of two sheets on the map. Further, it is also possible to provide an absolute range for coordinate axes of relative differential degree of stiffness.

Here, the standard denotes an entirely zero stiffness; that is, a value of relative differential degree of stiffness that becomes a standard when a paper sheet is no in paper quality sensor 12.

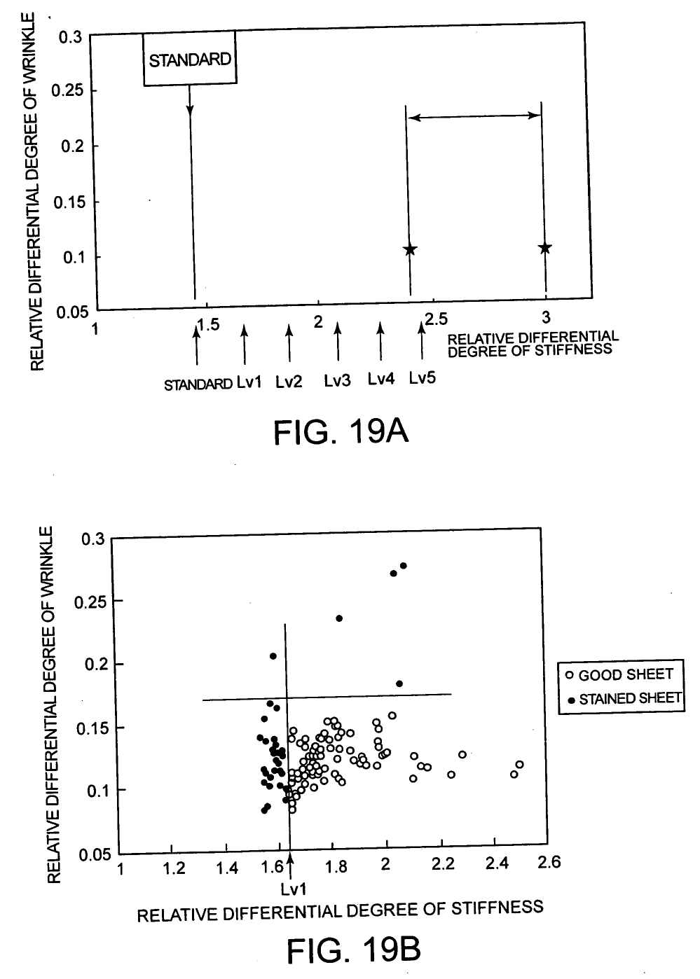

Next, based on this standard and range, for example, a map is divided into several stages as shown in FIG. 19A. When dividing a map, stages are decided based on the existence probability distribution data of stiffness of actually circulating paper sheets. When actually discriminating paper sheets for good/stained state, if it is desired to classify paper sheets at Lv 1 for an absolute standard/range, the good/stained state discrimination is made a shown in FIG. 19B.

Here, the map was divided into several stages in FIG. 19A but without dividing into several stages, pertinent values on the continuous axes may be given as threshold values. Further, regarding wrinkles, the advance work was not executed but the same advance work as that in the above may be conducted when necessary. Further, regarding wrinkles, using only one reference paper sheet, a advance work may be executed to determine a paper quality discriminating standard based on a difference between the result of that one sheet and the standard deviation 0.

From the above, it becomes possible to prepare a two-dimensional mapping in advance based on an absolute standard and range and give threshold values for adequate good/stained state of paper sheets.

The paper quality is determined according to the structure, functions and algorithm described above. Now, the flow of a series of operations of a cash arranger containing the above-mentioned paper quality discriminator will be explained below.

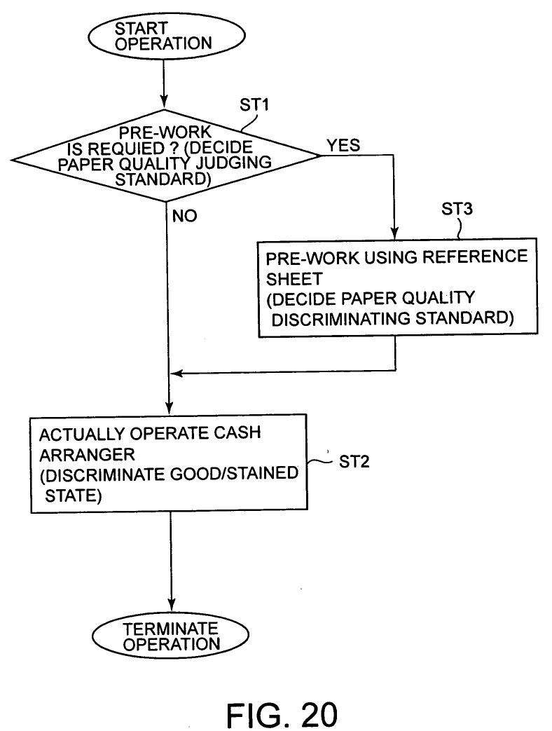

FIG. 20 is an example showing the flow of a cash processing operation.

After staring the operation and before entering the actual processing operation, it is determined whether the advance work is required (Step ST1). When the advance work is not required, the actual operation is started and paper sheets are discriminated for true or false, good or stained state and arranged orderly (Step ST2). When the advance work is needed, the above-mention work is performed and a paper quality discriminating standard is decided (Step ST3). When the paper quality discriminating standard is decided, the actual processing operation is started and the true or false and good or stained state are discriminated and the arrangement is performed (Step ST2)

Here, the advance work is not necessary to perform every time after the operation is started and it is sufficient to make it when the standard gets out of order for secular change of parts, in the periodic inspection, etc.

In this embodiment, paper quality is discriminated by providing an algorithm of the advance work for deciding a paper quality discrimination standard as described above without using a sensor output standard. The effect of this paper quality discrimination will be explained.

When a reaction force is measured by calculating a displacement from a sensor output standard, the calculated displacement is affected by variation in sensitivity of sensor between paper sheet discriminators and therefore, the calibration of sensor is necessary. However, in this embodiment, the sensor calibration is not required.

Further, on the assumption that a value of the reference position is a specific value, only when data after displacement is measured, it can be regarded to have the same meaning as the displacement calculated. However, in order to align a value of the reference position to a specific value for sensor incorporating variance between sheets discriminators, it becomes necessary to perform the precise mechanical adjustment when incorporating sensors or the calibration of sensors.

In this embodiment, when an algorithm is provided for the advance work to decide a paper quality discriminating standard, the paper quality discriminating capability is not affected even when the precise mechanical adjustment or the sensor calibration for aligning the reference position is not executed.

However, as a demerit of this embodiment, it is necessary to perform the advance work to decide a paper quality discrimination standard. This advance work, however, is not needed to perform for every time and when performs at the first time, it is considered there is not problem for a long period of time.

From the above, it is possible to make the discrimination of paper sheets for good or stained state matched to the discrimination of human hand feeling.

With respect to the expandability in this embodiment, 2 points will be presented below.

(1) With two units of paper quality sensor described above arranged in the direction orthogonal to the conveying direction of sheets symmetrically to the conveying center and two sensors are selectively used to discriminate paper quality according to front/back and top/bottom of paper sheets conveyed.

For example, in the case of an apparatus to which banknotes that are expected non-uniform in distribution of thickness and stiffness are conveyed in mix with normal banknotes, it is possible to check the direction of banknotes in advance and detect outputs by selectively using two sensors. Thus, it becomes possible to check the state of the same portions of banknotes and the good or stained state can be more properly discriminated.

(2) Stiffness of paper sheets is considered to change delicately as affected by ambient temperature/humidity. However, by providing temperature and humidity sensors in a cash arranger, a paper quality discriminating standard is corrected according to temperature or humidity and paper sheets are discriminated for good or stained state without affected by ambient temperature/humidity.

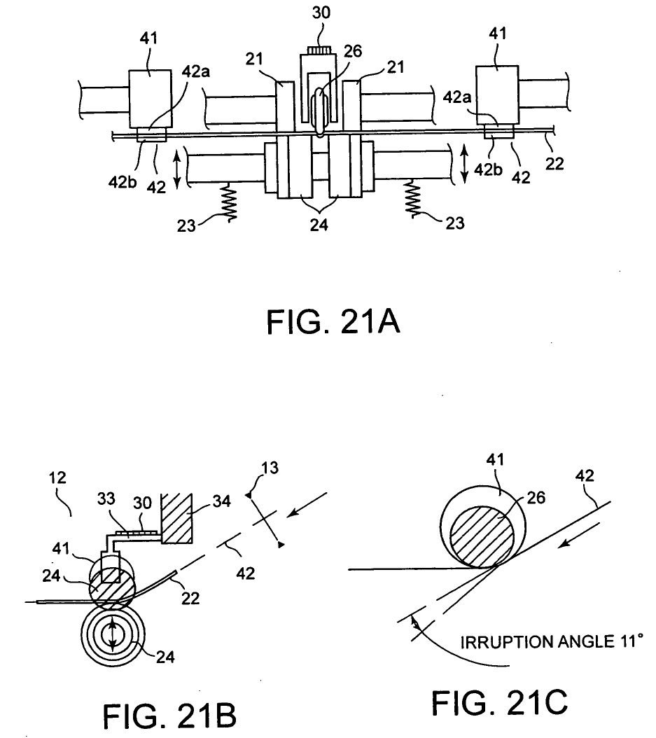

FIG. 21A to FIG. 21C show a sixth embodiment of paper quality sensor 12.

Paper quality sensor 12 is provided more than one unit with a specified space in the direction orthogonal to the conveying direction of paper sheet 22 and has a pair of reference rollers 21 that are driven as driving rollers. To the undersides of reference rollers 21, 21, pinch rollers 24 and 24 as thrusting rollers are contacted. Pinch rollers 24 and 24 are pressed toward reference rollers 21 and 21 by springs 23 and 23.

Between reference rollers 21 and 21, sensor roller 26 is provided rotatably and its lower end is overlapped on the paper sheet conveying surface by about 0.5 mm. Sensor roller 26 is held on a fixing wall 34 that is a fixing portion by a beam (a flexible member) 33 that is a holding portion. On the top of beam 33, strain gage 30 is provided as a strain detector.

At both sides of reference rollers 21 and 21, pulleys 41 and 41 are arranged. Conveyor belts 42 arranged in parallel with the paper sheet conveying direction are put over these conveyor belts 42. These conveyor belts 42 have upper and lower conveyor belts 42a and 42b that are overlapped each other. Both sides of paper sheets are held and conveyed by these upper and lower conveyor belts 42a and 42b.

Conveyor belt pairs 42 and 42 are curved at the portions that are put over pulleys 41 and 41. Between these curved portions, reference rollers 21 and 21, pinch rollers 24 and 24, and sensor roller 26 are provided.

In the above-mentioned structure, when a paper sheet 22 is conveyed between reference rollers 21, 21 and pinch rollers 24, 24 by conveyor belts 42 and 42, pinch rollers 24 are moved downward by a thickness of paper sheet 22 against the pressing force of springs 23 and 23 and sensor roller 26 moves upward according to the strength of stiffness of paper sheet 22. As a result of the movement sensor roller 26, beam 33 is deformed and its amount is detected by strain gage 30.

In the sixth embodiment, paper sheet 22 is held and conveyed by conveyor belt pairs 42 and 42 between reference roller pairs 21 and 21 and pinch rollers 24 and 24. Accordingly, the possibility of a paper sheet to hit rollers (driving rollers, pinch rollers) projecting to the conveying surface becomes less and the stable paper quality sensing is enabled even when the conveying velocity of a paper sheet 22 is increased.

Further, as reference roller pairs 21, 21, pinch roller pairs 24, 24 and sensor roller 26 are provided near the curved portion of conveyor roller pairs 42 and 42, a paper sheet 22 irrupts into the overlapped portion of sensor roller 26 in the state being conveyed along the curved portion of conveyor belt pairs 42 and 42. Therefore, there is an effect that an angle of irruption (for example, 11°) can be made small and the shock by the irruption can be suppressed.

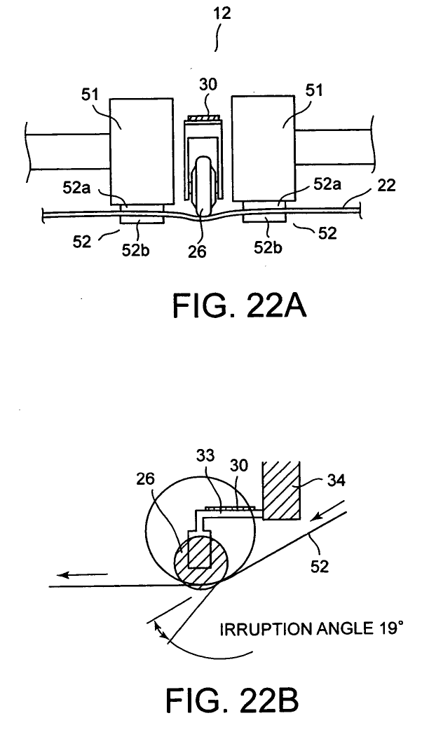

FIG. 22A and FIG. 22B show a seventh embodiment of paper quality sensor 12.

In the seventh embodiment, conveyor pulley pairs 51 and 51 are provided as a pair of reference rollers with a specified space between them in the direction orthogonal to the conveying direction of paper sheet 22. Conveyer belt pairs 52 and 52 are put over and curved on these conveyor belt pairs 52 and 52. Conveyor belt pairs 52 and 52 have upper and lower conveyor belts 52a and 52b which are overlapped each other and arranged in parallel along the conveying direction of paper sheet 22. Sensor roller 26 is provided between conveyor pulley pairs 51 and 51 and located near the curved portion of conveyor belt pairs 52 and 52.

In the seventh embodiment, sensor roller 26 is also held by fixing wall 34 that is a fixing portion via beam (flexible member) 33 that is a holding portion likewise the sixth embodiment. On the top of beam 33, strain gage 30 is provided as a strain detector.

As explained in the sixth and the seventh embodiments, sensor roller 26 is held by fixing wall 34 via beam 33 and the stiffness of paper sheet 22 is detected by detecting a deflection amount of beam 33 resulting when paper sheet 22 passes sensor roller 26 by strain gage 30. Therefore, since up-and-down motion of the sensor roller 26 can be made smaller than the case where spring 25 like before is intervened, vibration of the sensor roller 26 can be suppressed.

As explained above, in this invention, paper sheets are held and conveyed to the sensor roller by the conveyor belt pairs and therefore, the stable conveying can be expected in the high-speed conveying and the speed up of the conveying speed is enabled.

Further, the sensor roller is provided near the curved portion of the conveyor belt pairs and paper sheets are irrupted to this sensor roller while curving along the curved portion of the conveyor belt pairs and vibration by the shock when irrupted can be reduced.

Further, indexes expressing relative differences of paper sheets are calculated and a mapping is formed for the calculated indexes and threshold values or discriminating standards are given to this map in advance, and good or stained state of paper sheets are discriminated two-dimensionally according to stiffness and degree of wrinkle of paper sheet and thus, it becomes possible to make the discrimination matched to the human hand feeling.

Further, because the displacement of the sensor roller is not obtained, there is such an effect that the calibration of sensors for variance in the sensitivity of sensors is unnecessary.

Also, position data after change of the sensor roller is used directly as discrimination data and therefore, there are such effects that precise mechanical adjustment for aligning the reference positions of sensors and the calibration of sensors are not required.

1. A sheets discriminator comprising:
a pair of conveyor belts provided in parallel with the conveying direction with a specified space in the direction orthogonal to the conveying direction of sheets and put over pulleys to curve so as to hold and convey sheets along the conveying path;
a pair of reference rollers provided between the conveyor belt pairs with a specified space in the direction orthogonal to the conveying direction of the sheets;
a pair of thrusting rollers provided in contact with the conveyor belt pairs to thrust the sheets against the reference rollers;
a sensor roller provided between the reference roller pairs projecting from the sheet conveying surface, and moves in the direction orthogonal to the sheet conveying surface when the sheets that are held and conveyed by passed; and
a position sensor to detect the moving position of the sensor roller or to detect the surface position of the sheets when the sheets pass the sensor roller.

2. The sheets discriminator according to claim 1 further comprising:
calculating means for calculating indexes expressing a relative difference based on the detected data of the position sensor; and
discriminating means for discriminating the good or stained state of the sheets by comparing the index calculated by the calculating means with pre-given threshold value or deciding standard.

3. The sheets discriminator according to claim 2, wherein the calculating means calculates indexes expressing relative differences of the state of the sheets based on only data excepting the detected data when the sheets irrupted to the sensor roller and evacuated therefrom.

4. The sheets discriminator according to claim 2, wherein the indexes expressing the state of the sheets are amounts relative to stiffness of the sheets (a relative differential degree of stiffness),
the calculating means calculates a relative differential degree of stiffness by acquiring plural position data that is a characteristic amount correlative to stiffness of the sheets from a single sheet, a frequency distribution of the position data and a peak value in the frequency distribution and/or an average value of position data.

5. The sheet discriminator according to claim 2, wherein an index expressing the state of the sheets is an amount relative to degree of wrinkle of the sheet (a relative differential degree of wrinkle),
the calculating means calculates a relative differential degree of wrinkles by acquiring plural position data that is a characteristic amount correlative to wrinkles of the sheets from a single sheet, a frequency distribution of the position data and a standard deviation in the frequency distribution.

6. The sheet discriminator according to claim 1, wherein the reference roller is fixed to a fixing portion of a main body of the discriminator,
the position sensor includes:
a holder to hold the sensor roller to the fixing portion of the main body of the discriminator via a flexible member; and
a strain sensor provided to the flexible member to detect a strain of the flexible member when the sheets pass the sensor roller.

7. The sheet discriminator according to claim 6, wherein the strain sensor includes a strain gage.

8. The sheet discriminator according to claim 1, wherein the sensor roller includes a ball bearing.

9. A sheet discriminating method using a position sensor that contacts sheets conveyed by a conveying unit to detect the moving position of a sensor roller moving in the direction orthogonal to a conveying surface of the sheet or a surface position of the sheet comprising:
collecting digital data group digitized to minute unit time from a single sheet based on a voltage value as an output result from the position sensor;
obtaining a relative differential degree of stiffness by obtaining a frequency distribution of position data as index expressing stiffness of the sheet from the collected digital data group and calculating a peak value or an average value in the frequency distribution; and
discriminating good or stained state of the sheets based on the comparison of the relative differential degree of stiffness with a pre-stored threshold value.

10. A sheet discriminating method using a position sensor that contacts sheets conveyed by a conveying unit to detect the moving position of a sensor roller moving in the direction orthogonal to a conveying surface of the sheets or a surface position of the sheets comprising:
collecting digital data group digitized to minute unit time from a single sheet based on a voltage value as an output result from the position sensor;
obtaining a relative differential degree of stiffness by obtaining a frequency distribution of position data as index expressing stiffness of the sheet from the collected digital data group and calculating a peak value or an average value in this frequency distribution;
obtaining a frequency distribution of position data from the collected digital data group as an index expressing the degree of wrinkles of the sheet and obtaining a relative differential degree of wrinkles in the frequency distribution by calculating a standard deviation in the frequency distribution; and
discriminating the good or stained state of the sheets based on the comparison of the relative differential degree of stiffness and wrinkles with a pre-stored threshold values.

11. A sheet discriminating threshold value deciding method of a sheet discriminator using a position sensor that contacts sheets conveyed by a conveying unit to detect a moving position of the sensor roller moving in the direction orthogonal to a conveying surface of the sheets or a surface position of the sheets comprising:
collecting digital data group digitized to minute unit time from a single sheet based on a voltage value as a output result from the position sensor for a first reference sheet and a second reference sheet conveyed by the conveying unit;
obtaining frequency distributions of position data as indexes expressing stiffness of the first and the second reference sheets from the collected digital data group and obtaining a relative differential degree of stiffness by calculating a peak or an average value in the frequency distribution;
mapping relative differential degrees of stiffness of the first and second reference sheets, respectively;
estimating a standard for zero stiffness of sheets from the positions of the first and the second reference sheets on the map;
setting plural threshold values by dividing the map into plural stages based on the standard; and
selecting one threshold value out of the plural threshold values.

12. A sheet discriminating method comprising:
conveying at least two sheets of reference sheets along a conveying path;
detecting the state of the conveyed reference sheets;
calculating relative differential data of at least two reference sheets based on the detected data;
calculating a difference from the calculated relative differential data of at least two reference sheets, obtaining an absolute point of origin for the relative differential data based on the calculation result, obtaining a discriminating threshold value for the good or stained state from the point of origin and the relative differential data and storing the discriminating threshold value;
conveying the sheets along the conveying path after storing;
detecting a state of the conveying sheets;
obtaining data expressing the relative difference of the state of the sheets based on the detected data of the conveying sheets; and
discriminating the sheets for the good or stained state based on the discriminating value for the good or stained state stored as expressing a relative difference of the state of the obtained sheets.
